(19) United States
(12) Patent Application Publication
(10) Pub. No.: US 2012/0182179 A1
(43) Pub. Date: Jul. 19, 2012

(54) METHOD FOR THE COMPUTER-SUPPORTED CREATION AND/OR UPDATING OF A REFERENCE MAP FOR A SATELLITE-SUPPORTED POSITIONING OF AN OBJECT

(76) Inventors: Joachim Bamberger, Krailling (DE); Marian Grigoras, Neubiberg (DE); Andrei Szabo, Ottobrunn (DE)

(21) Appl. No.: 13/499,248

(22) PCT Filed: Aug. 13, 2010
(86) PCT No.: PCT/EP10/61812

§ 371 Date: Mar. 29, 2012

(51) Int. Cl. G01S 19/40

(52) U.S. Cl. 342/357.23

(57) ABSTRACT

Distance dimensions in a predetermined spatial region of a reference map are corrected during positioning of an object from which dimensions the object position is determined from a satellite signal, received via a receiving unit at the location of the object, representing the distance from the satellite to the object. The distance dimensions are determined form received satellite signals using a satellite-supported receiver unit in a plurality of locations of an object in the predetermined spatial region. Using a predetermined object position, which can be known in advance or estimated, distance dimension which corresponds to the predetermined object position are back-calculated by incorporating the satellite positions of the satellites from which the satellite signals are received. Based on the difference between the respectively determined and back-calculated distance dimensions, a correction for at least part of the predetermined spatial region around the specified object position is stored and/or updated.

### CROSS REFERENCE TO RELATED APPLICATIONS

This application is the U.S. national stage of International Application No. PCT/EP2010/061812, filed Aug. 13, 2010 and claims the benefit thereof. The International Application claims the benefits of European Application No. 09012346.4 filed on Sep. 29, 2009 and German Application No. 10 2010 011 982.2 filed on Mar. 19, 2010, all three applications are incorporated by reference herein in their entirety.

### BACKGROUND

Described below is a method for the computer-aided generation and/or updating of a reference map for satellite-based positioning of an object and to a satellite-based positioning method.

In the satellite-based determination of the position of an object, based for example on the GPS position finding system (GPS=Global Positioning System), the position of the object on the earth's surface is determined based on corresponding signals from satellites. In such a system the determination of the position is based on a time-of-flight measurement of a plurality of satellite signals and a corresponding multilateration of the distances determined therefrom between the satellites and the object. Satellite-based positioning systems generally have a very high degree of accuracy in non-built-up areas. However, there exists the problem that in built-up areas the distance measurements are distorted due to the satellite signals being reflected off buildings, thereby adversely affecting the accuracy of the positioning.

### SUMMARY

An aspect is to improve the accuracy of satellite-based position finding.

In the method described below, a reference map for satellite-based positioning of an object is generated and/or updated, there being stored in the reference map a correction for a predetermined spatial region by which in the positioning of an object in the predetermined spatial region distance measures are corrected from which the object position is determined, a distance measure being determined from a satellite signal of a satellite, which signal is received by way of a satellite-based receiving device at the location of the object. A distance measure in this case represents the distance from the satellite to the object, i.e. the distance measure can either represent the distance itself or a variable dependent thereon, such as e.g. the time of flight of the signal.

In the method described below, the distance measures are determined in each case from received satellite signals at a plurality of locations of an object lying in the predetermined spatial region by a satellite-based receiving device, which can be e.g. a GPS receiving device or alternatively a receiving device based on another system (e.g. Galileo). In this case the individual distance measures do not have to be determined by the same receiving device, but rather the distance measures may possibly have been determined by arbitrary receiving devices moving in the spatial region.

Next, an object position for a respective location is predetermined from the plurality of locations, it being possible for the predetermined object position to be for example a pre-known object position or an estimated object position which has been determined by the satellite-based receiving device e.g. without the assistance of the reference map.

Thereafter, distance measures corresponding to the predetermined object position are then back-calculated from the predetermined object position and the satellite positions of the satellites from which the satellite signals are received at the respective location previously. In this case a significant difference can exist between the distance measures determined at the respective location and those back-calculated, in particular in built-up areas. In order to take this difference into account in the reference map in an appropriate manner during the subsequent positioning, the correction for at least a part of the predetermined spatial region around the predetermined object position is stored and/or updated, based on the difference between the distance measures determined at the respective location and the corresponding back-calculated distance measures.

In this case the correction can be stored or updated by methods known per se. In particularly embodiment variants, methods for field-strength-based positioning known from the related art are used which can also be applied analogously to satellite-based methods. In particular the methods described in B. Betoni Parodi et al.; “Initialization and Online Learning of RSS Maps for Indoor/Campus Localization”, 2006 IEEE/ION Position, Location and Navigation Symposium, pp. 164-172; B. Betoni Parodi et al.; “Algebraic and Statistical Conditions for Use of SLL”, European Control Conference 2007; and DE 10 2006 044 293 A1 can be employed, the entire disclosure content of the publications being incorporated by reference in the content of the present application. How the updating of a reference map for field-strength-based positioning methods described in these documents can be applied to satellite-based positioning methods is explained with reference to an exemplary embodiment in the detailed description.

In an embodiment variant of the method, the reference map is represented by correction factors at a multiplicity of nodal points in the predetermined spatial region, the correction factors for one or more nodal points in spatial proximity to the predetermined object position being stored and/or updated. The proximity can in this case be specified in an arbitrary manner. In particular the proximity can be defined by way of a corresponding function whose values decrease with increasing distance between nodal point and predetermined object position, such that as of a specific distance between nodal point and predetermined object position no further updating of correction factors takes place.

In a further variant, the predetermined object position is determined based on the distance measures determined in and corrected by correction of the reference map. In this way an unsupervised learning by the reference map can be achieved in which the object position used for the learning does not have to be known exactly.

In a further embodiment variant of the method, the correction factors of one or more nodal points in spatial proximity to an estimated object position are used for the determination of the predetermined object position. The spatial proximity can in this case be specified in such a way that in the determination of the predetermined object position only correction factors of that nodal point are used which is at the shortest distance from an estimated object position. In this case the estimated object position can be e.g. the position of the object located without use of the reference map or a position which has been determined in addition or alternatively by other sensors, such as e.g. via odometric or gyroscopic sensors.

In a further embodiment of the method, a known object position is predetermined and the correction is stored and/or updated at the known object position and/or for one or more nodal points of the reference map in spatial proximity to the known object position. According to this variant of the method, a supervised learning method for generating and/or updating a reference map based on known object positions is created.

In the method the distance measure may be determined by way of a time-of-flight measurement of the corresponding received satellite signal. The satellite position of a respective satellite used in the method is beneficially encoded in the received satellite signal and/or can be derived from the received satellite signal, in particular based on a timestamp in the satellite signal which specifies the transmit time of the signal, and based on the pre-known orbit of the corresponding satellite.

In order to take into account that position finding can be performed at different satellite positions, in an embodiment variant of the method the correction is stored in the reference map as a function of the satellite positions present at the time of the positioning, the correction being generated and/or updated for those satellite positions for which satellite signals are received.

In the variant in which the reference map is realized by way of nodal points, correction factors for a plurality of satellite positions are stored and/or updated for a respective nodal point of the reference map. The correction may be stored and/or updated in this case in such a way that for a correction factor for a nodal point corresponding to the satellite position for which a distance measure is determined, a correction term which is dependent on the difference between the distance measure determined and the distance measure back-calculated is added thereto or subtracted therefrom. Whether the correction term is added thereto or subtracted therefrom is dependent on the sign-related definition of the correction term. If, during the subsequent positioning, the distance measure is corrected by addition thereto of the correction factor, the correction term is defined as the difference between the back-calculated distance measure and the determined distance measure. In this case the correction term can be defined analogously to the methods described in the publications listed above, except that a difference of distance measures is now used instead of a difference in field strength values.

The correction term may be dependent on the distance between the nodal point and the object position predetermined and decreases as the distance increases. In this case the correction term can include a function that is dependent on the distance between the nodal point and the object position predetermined, e.g. a triangulation function or a Gaussian function. The functions described in the publications listed above can again be used in this case.

In a further embodiment variant of the method, distance measures are initially determined by way of one or more satellite-based receiving devices for a plurality of locations of an object, the distance measures being transmitted to a central computing unit which subsequently performs for each location and thus, generates and/or updates a reference map. In this variant, data is gathered in advance by way of any receiving devices, which data may originate from any users having known receiving devices. In the case of unsupervised learning it is not even necessary here to know the exact positions of the users. After sufficient data has been gathered, the reference map can finally be generated and/or updated.

In addition to the above-described method for generating and/or updating a reference map, also described is a method for satellite-based positioning of an object, wherein the positioning takes place with the aid of a reference map that has been generated and/or updated by the above-described method. In this case distance measures are determined by a satellite-based receiving device at the location of the object from the satellite signals of satellites, a respective distance measure representing the distance from a satellite to the object. The distance measures are subsequently corrected by a correction from the reference map and the object position is determined based on the corrected distance measures.

If the reference map is represented by correction factors for a plurality of nodal points in a predetermined spatial region, a respective distance measure may be corrected using the correction factor of that nodal point which is at the shortest distance from an estimated object position. Depending on definition, the correction factor is in this case added to or subtracted from the distance measure.

In an embodiment variant, a reference map is updated and/or generated based on the above-described method simultaneously with the position finding performed based on the object position determined during the positioning. The determined object position accordingly represents the predetermined object position which is used in back-calculating.

In another variant of the positioning method, the reference map is stored on a central computing unit, at least a part of the reference map being transmitted to the object and the object positions being determined in the object from the distance measures which are corrected using the correction of the at least one part of the reference map, and/or the distance measures determined at the location of the object being transmitted to the central computing unit which subsequently determines the object position with the aid of the reference map and transmits same to the object.

In addition to the above-described methods, also described is a device for the computer-aided generation and/or updating of a reference map for satellite-based positioning of an object, a correction for a predetermined spatial region being stored in the reference map and used during the positioning of an object in the predetermined spatial region to correct distance measures from which the object position is determined, a distance measure being determined from a satellite signal of a satellite which is received by way of a satellite-based receiving device at the location of the object, and the distance measure representing the distance from the satellite to the object. In this case, during operation of the device:
a) the distance measures are determined by a satellite-based receiving device at a plurality of locations of an object lying in the predetermined spatial region from received satellite signals in each case and/or the distance measures are read in;
b) an object position for a respective location is predetermined from the plurality of locations;
c) distance measures corresponding to the predetermined object position are back-calculated from the predetermined object position and the satellite positions of the satellites from which the satellite signals are received at the respective location;
d) the correction for at least a part of the predetermined spatial region around the predetermined object position is stored and/or updated based on the difference between the respective determined and back-calculated distance measures.

The device is in this case may be embodied in such a way that any variant of the above-described method can be performed by the device.

In addition to the just described device for generating or updating a reference map, also described is a device for satellite-based positioning of an object, the positioning being performed with the aid of the reference map generated and/or updated by way of the above-described method. In this case, during operation of the device:
distance measures are determined from satellite signals of satellites by a satellite-based receiving device at the location of the object, a respective distance measure representing the distance from a satellite to the object;
the distance measures are corrected using the correction of the reference map;
the object position is determined based on the corrected distance measures.

In this case the device may be embodied in such a way that any variant of the above-described positioning method can be performed by the device.

### BRIEF DESCRIPTION OF THE DRAWINGS

These and other aspects and advantages will become more apparent and more readily appreciated from the following description of the exemplary embodiments, taken in conjunction with the accompanying drawings of which:

FIG. 1 is a schematic representation of satellite-based positioning serving to explain the problem to which the method is directed; and

FIG. 2 is a schematic representation of the positioning of an object in combination with the updating of a reference map based on an embodiment variant of the method.

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

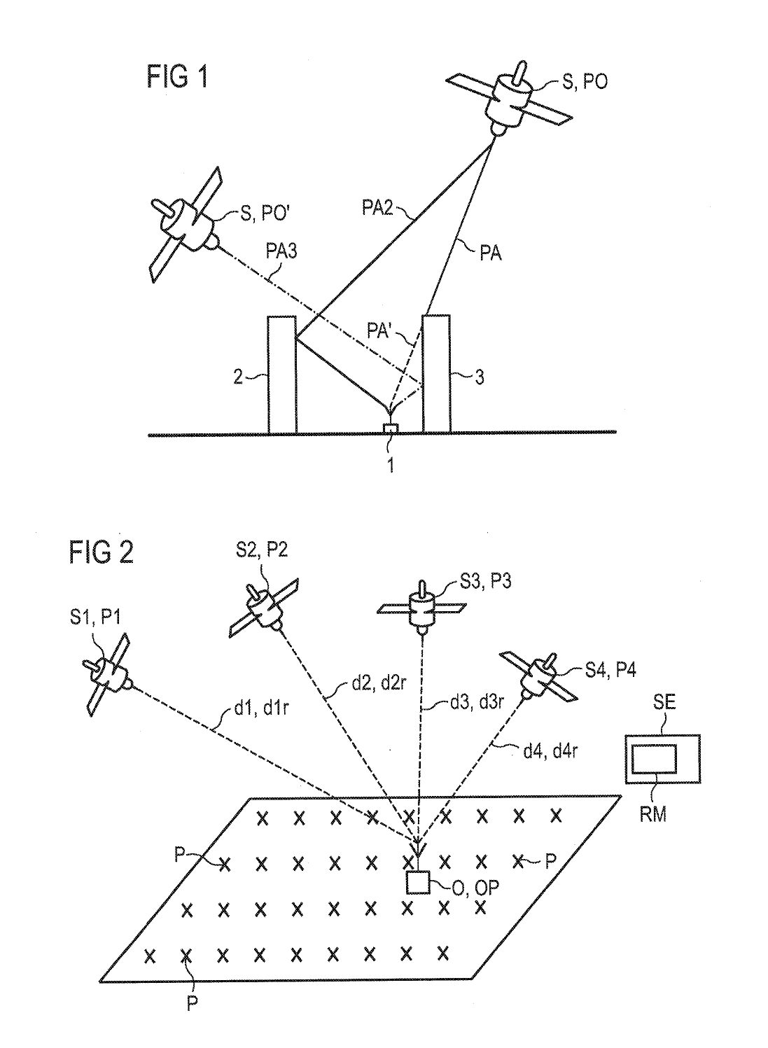

Satellite-based position finding, together with the associated addressed problem of determining a position in heavily built-up areas, will initially be explained in general terms hereinbelow with reference to FIG. 1. FIG. 1 shows in a side view a satellite-based receiving device in the form of a GPS receiver 1 whose position on the earth's surface is to be determined by way of satellite signals from a plurality of satellites. The receiver 1 is in this case located in a heavily built-up area, as indicated by two buildings 2 and 3 represented as rectangles. In order to find its three-dimensional position, the GPS receiver 1 normally receives the signals from four satellites, although in this case the GPS measurement principle is explained for clarity of illustration reasons only based on satellite S shown in FIG. 1, which during the position finding is shown at a position PO and at a position PO′.

Satellite-based position finding by the receiving device 1 operates such that the receiving device evaluates information contained in received satellite signals. Encoded within the satellite signals is firstly a timestamp which establishes the time instant at which the signal is transmitted. The timestamp can be used to calculate what is called the pseudorange, which represents an embodiment variant of a distance measure. The pseudorange is determined in the GPS receiver by way of a time-of-flight measurement of the signal and represents the distance between the satellite S and the GPS receiver 1. Secondly, the timestamp can be used to back-calculate the satellite position by methods known per se. If a GPS receiver now receives corresponding signals from four satellites, it can determine its position by way of the pseudoranges determined therefrom, which will be referred to hereinafter as distances, as well as the corresponding satellite positions by way of multilateration.

In a built-up area, as indicated by the buildings 2 and 3 in FIG. 1, there exists the problem that errors occur in the measurement of the distance between the satellites S and the GPS receiving device 1. If the satellite is located at the position PO, the distance is not measured along the direct line of sight according to the path PA due to the fact that a satellite signal on the path is shielded by the building 3, as indicated by the dashed portion PA′ of the path PA. Instead, the GPS receiving device receives the satellite signal along the path PA2, the signal having been reflected off the building 2. The consequence of this is that too long a time-of-flight and hence too long a distance is measured between the satellite S and the GPS receiving device 1, leading to measurement errors. The same problem also occurs at the position PO' of the satellite S. At this position the satellite signal again cannot be received in the receiver 1 along a direct path due to the presence of the building 2, but is received via the path PA3, according to which the signal is reflected off the building 3.

By the two satellite positions PO and PO′ shown it is furthermore made clear that the error caused by the reflection is also dependent on the satellite position. In particular the error at the satellite position PO′ is less than at the satellite position PO, since the difference between the direct line of sight and the correspondingly reflected signal paths is smaller for the position PO′ than for the position PO.

In order to achieve an improvement in position determination in built-up areas, it is therefore proposed in the embodiment variant explained below that use be made of a reference map which is known per se from field-strength-based positioning of objects. A method known from field-strength-based positioning for position finding and simultaneous updating of the reference map is in this case applied analogously to satellite-based positioning.

FIG. 2 shows a perspective representation of satellite-based positioning of an object O which includes a corresponding GPS receiver, with the assistance of the aforementioned reference map. The reference map is represented in this case by a multiplicity of nodal points in a predetermined spatial region, the nodal points being indicated in FIG. 2 by corresponding crosses and being labeled in some cases with the reference sign P. A correction factor for a plurality of different satellite positions is therein stored at each of the nodal points, the correction factor being used to correct the object position OP determined by the object O without the correction in a suitable manner. The correction factor is used here to correct the distances from corresponding satellites that were determined in the GPS receiver by way of time-of-flight measurement, the correction factor being added to or subtracted from the corresponding distances depending on normalization. Based on the thus corrected distance values, a corrected object position is then determined which represents an improvement over the originally determined object position OP.

FIG. 2 shows a scenario in which the object O receives satellite signals from four satellites S1, S2, S3 and S4 at corresponding satellite positions P1, P2, P3 and P4. Based on these satellite signals, the corresponding distances d1, d2, d3 and d4 between the respective satellite S1, S2, S3 and S4 and the object O are first determined by way of time-of-flight measurement. Next, based on an estimated position of the object O, which position can correspond for example to the object position determined without correction, that nodal point of the reference map is determined which lies closest to the estimated object position. That correction factor corresponding to the satellite position for which a respective distance has been determined is then extracted for the nodal point. As already mentioned above, the distance is then corrected accordingly by addition or subtraction using the correction factor.

In the scenario shown in FIG. 2, the reference map is labeled with the reference sign RM and stored in a central computing unit SE taking the form of a server, the part of the reference map RM relevant to the position finding being transferred from the server over a corresponding (e.g., wireless) data link to the object O. It is, however, also possible for the object O to transmit its measurement data to the server SE, which thereupon makes use of the reference map RM stored there to determine a corrected object position which it in turn transfers to the object O.

In the scenario shown in FIG. 2, in addition to finding the position of the object O, corresponding correction factors in the reference map are also updated simultaneously based on the newly added object position. This happens in the object O in that the distances between the object O and the respective satellites are back-calculated from the object position corrected by way of the reference map with the aid of the known satellite positions, the back-calculated distances being designated in FIG. 2 by d1r, d2r, d3r and d4r. Next, based on the difference between the respective determined distances d1, d2, d3 and d4 and the respective back-calculated distances d1r, d2r, d3r and d4r, the corresponding correction factor is updated at nodal points of the reference map in the vicinity of the object position OP. In this case the correction terms explained in the publications listed above can be used in the form of update surfaces. In particular the updating is performed analogously based on the update surface according to equation (7) of DE 10 2006 044 293 A1. In this case the expression Δp there is replaced by the difference between the respective determined and back-calculated distance. The function f(r) of equation (7) can be chosen here in the same way as in equation (9) of DE 10 2006 044 293 A1, where r denotes the distance of a corresponding nodal point from the located object position.

In this way an updated correction factor e₁^{new} can be determined for a correction term e₁ of the corresponding distance dl of FIG. 2, which updated correction factor reads as follows:

e₁^{new}=e₁+(d1r−d1)·f(r),

where f(r) can be chosen analogously to equation (9) or (10) of DE 10 2006 044 293 A1. It is achieved by the function f(r) that corresponding nodal points are updated only in a predetermined area around the object position, since for greater distances from the object position the function converges toward zero.

The correction factors for the distances of the other satellite positions S2 to S4 can also be corrected in an analogous manner to the above-described updating of the correction factor e₁ for the distance dl based on the satellite position S1. In particular in the case where the object O is moving in a built-up area, an improved positioning accuracy for the object O can be achieved by taking into account the corresponding correction factors. In the scenario shown in FIG. 2, the correspondingly updated correction factor is stored in the reference map RM in the central computing unit SE, the central computing unit SE if necessary also being able to perform the calculation of the correction factor.

In the scenario shown in FIG. 2, the reference map may already have completed the learning phase in advance by way of suitable GPS measurements and can subsequently be updated repeatedly during the positioning of the object O. Embodiment variants of methods by which a reference map carries out its learning in advance are explained hereinbelow.

In one embodiment variant, an unsupervised learning phase is performed, wherein firstly GPS measurements of arbitrary objects moving in the spatial region of the reference map are collected automatically by GPS receivers. These measurements, which include the corresponding distances from the satellites as well as the satellite positions, can be carried out by any users using commercially available GPS receivers. The receivers simply need to be capable of storing the measurement information until it can finally be transferred in a suitable manner to the central computing unit SE. If necessary, the transfer can also be performed online by way of a corresponding data link between GPS receiver and computing unit SE.

After the measurements have been collected, the reference map is first initialized in the server SE, i.e. correction factors of zero are stored for all nodal points. Based on the collected measurements, which are subsequently processed step by step in any order, the correction factors are then updated at the nodal points of the respective reference map, the update processing proceeding analogously to the above-described updating based on corresponding update surfaces by which correction factors are updated based on a function f(r) and as a function of the difference between a back-calculated and a determined distance.

Prior to the start of the learning phase of the reference map RM, the server SE can, where appropriate, also perform a verification in which a check is made to determine whether the collected measurement values are representative of the region in which the reference map is to be subject to learning, i.e. whether the measurements also substantially cover the entire region that is to be learned, as well as whether on the one hand they lie close enough to one another and on the other hand they cover a plurality of satellite positions. If this is not the case, the learning by the reference map can initially be deferred while further measurements are awaited.

The above-described determination of corresponding correction factors at nodal points of a reference map constitutes an embodiment variant. However, other known methods for learning by the reference map can also be used. In particular it is possible, if appropriate, to learn a suitable correction function instead of learning nodal points in the reference map, such that the reference map is represented in the learned region by a function which specifies the correction factor that is to be used accordingly as a function of an estimated object position (e.g. an object position determined without correction). For example, suitable optimization methods, such as e.g. maximum expectation or genetic algorithms, can be employed together with suitably defined cost functions for determining the correction function.

Once corresponding correction factors for the nodal points of the reference map have been learned by the above-described unsupervised learning process, these must be distributed among the GPS receivers of corresponding objects that are used for the position finding. As described above, the possibility exists here that during the positioning the object in question will retrieve the relevant part of the reference map from the server SE and process it in situ in a suitable manner. Equally, the measurement data of GPS position finding in the object O can be transmitted to the server SE, which subsequently determines the object position corrected by the reference map and sends it to the object O. The advantage of the last-cited variant is that the calculations for determining the corrected object position do not have to be performed by the object O itself, which has only limited computing resources at its disposal in comparison with the central computing unit SE. However, the disadvantage of the last-cited variant is that it is necessary to perform a data transfer each time position finding takes place.

The above-described methods for position finding or, as the case may be, for learning by the reference map can potentially be improved further through the use of additional information during the position finding or learning, insofar as such information is available. Such additional information can include for example the positions of objects and in particular buildings in the area of the reference map to be learned, which information can be taken e.g. from cartographic maps. This information can be used for example to specify a region in which it is necessary to learn correction factors of the reference map, since errors are likely to occur here due to reflections. A corresponding correction by the reference map is then dispensed with in other regions. Similarly, a movement of the object correspondingly sensed by additional sensors (such as e.g. by way of odometry or gyroscopy) can be used as additional information. This information can also serve in particular for more accurately estimating a position of the object, it being possible to use the estimated position e.g. for back-calculating the corresponding distances from the satellites. Furthermore, the estimated positions from other localization systems for example can also be used as additional information, such as e.g. based on field-strength-based localization systems which estimate the position of an object by way of the field strength of corresponding radio networks, such as WLAN and/or DECT.

In a further embodiment it is possible, during the learning phase of the reference map, to use permanently predetermined points in space as object positions, based on which distances from satellites are back-calculated, whenever the result yielded by known satellite-based positioning is that the positioning accuracy is very high. Furthermore, the region in which learning by the reference map is performed should have a certain minimum size in order in this way to avoid problems during learning at the border of the reference map. In particular the learning region should be at least ten times larger than the accuracy of the satellite-based positioning in the vicinity of built-up areas.

An unsupervised learning method for determining corresponding correction terms in a reference map has been described in the foregoing. It may, however, also be possible to use a supervised learning method or manual calibration for determining a suitable reference map. In this case the satellite-based measurements are not received by arbitrary receivers whose positions are unknown; rather, the precise position of the GPS receiver is known for each measurement. For example, this precise position can be taken from a map or determined by way of corresponding odometric or gyroscopic sensors. In this case, in order to determine or update the corresponding correction factors, an estimated object position or the object position determined without correction is no longer used, but instead use is made of the known object position from which, analogously to the above-described methods, the distances from the corresponding satellites are back-calculated. The correction factor is determined or updated based on the difference between the measured and back-calculated distances. By this method a precise calibration of a reference map is achieved for subsequent position finding. The method is, however, associated with higher overhead, since arbitrary GPS measurements cannot be used for generating the reference map, but only such measurements in which the object position is also known in advance. Generally, therefore, the area of the reference map requiring to be calibrated must be traversed manually by a person performing a GPS measurement for correspondingly pre-known positions.

The methods described in the foregoing for generating or updating a reference map and the satellite-based position finding based thereon have a number of advantages. In particular position finding in heavily built-up areas, such as e.g. in inner cities, can be significantly improved using the corresponding reference map. Such an improvement in position finding can be turned to advantage in particular by official authorities in urban areas such as fire department, police and the like, for reaching scenes of accidents or danger points more quickly. Equally, private individuals or companies, such as e.g. taxi firms, can also make use of the improved position finding. A further advantage of the method resides in the fact that while the position finding is being performed the correction in the reference map can also be continuously improved by way of a simultaneously performed online learning process. In particular changed conditions in terms of building development in a built-up area can also be taken into account by the constantly updated reference map.

A description has been provided with particular reference to preferred embodiments thereof and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-19. (canceled)

20. A method for computer-aided generation and/or updating of a reference map for satellite-based positioning of an object, the reference map storing a correction for a predetermined spatial region to correct, as a position of the object in the predetermined spatial region is determined, distance measures from the object to a satellite based on a satellite signal received by at least one satellite-based receiving device at the object, comprising:
determining satellite distance measures at a plurality of locations of the object in the predetermined spatial region from satellite signals received by the at least one satellite-based receiving device;
obtaining a predetermined object position for a selected location in the plurality of locations;
obtaining calculated distance measures corresponding to the predetermined object position by back-calculating from the predetermined object position and satellite positions of satellites from which the satellite signals are received at the selected location; and
storing corrections for at least a portion of the predetermined spatial region around the predetermined object position based on a difference between the satellite distance measures and the calculated distance measures.

21. The method as claimed in claim 20, wherein the reference map is represented by correction factors at a plurality of nodal points in the predetermined spatial region, and
wherein said storing stores the correction factors for at least one nodal point in spatial proximity to the predetermined object position.

22. The method as claimed in claim 21, wherein said obtaining the predetermined object position is based on the satellite distance measures and the corrections previously stored in the reference map.

23. The method as claimed in claim 22, wherein said obtaining of the predetermined object position uses the correction factors of at least one nearby nodal point closest to an estimated object position of the object.

24. The method as claimed in claim 23,
wherein said obtaining of the predetermined object position uses a known object position, and
wherein said storing stores the corrections at the known object position and/or the at least one nodal point of the reference map in spatial proximity to the known object position.

25. The method as claimed in claim 21, wherein said storing stores the corrections in the reference map as a function of the satellite positions and for the satellite signals received during said determining.

26. The method as claimed in claim 25, wherein said storing stores the correction factors for the satellite positions for the at least one nodal point in the reference map.

27. The method as claimed in claim 26, wherein said storing includes adding or subtracting a correction term, dependent on the difference between the satellite distance measure and the calculated distance measure, to or from the correction factor for the at least one nodal point corresponding to a satellite position for which the satellite distance measures are determined.

28. The method as claimed in claim 27, wherein the correction term is dependent on a proximity distance between the at least one nodal point and the predetermined object position and decreases as the proximity distance increases.

29. The method as claimed in claim 28, wherein the correction term includes one of a triangulation function and a Gaussian function dependent on the proximity distance between the at least one nodal point and the predetermined object position.

30. The method as claimed in claim 21,
further comprising transmitting the satellite distance measures, initially determined by the at least one satellite-based receiving device for the plurality of the locations of the object, to a central computing unit, and
wherein the central computing unit obtains the predetermined object position, back calculates the calculated distance measures and stores the corrections, for each of the locations to at least one of generate and update the reference map.

31. A method for satellite-based position detecting of an object based on a reference map generated and/or updated by storing a correction for a predetermined spatial region to correct distance measures from the object to a satellite, comprising:
determining satellite distance measures at a plurality of locations of the object in the predetermined spatial region from satellite signals received by at least one satellite-based receiving device;
obtaining predetermined object positions for respective locations;
obtaining calculated distance measures corresponding to the predetermined object positions by back-calculating from the predetermined object positions and satellite positions of satellites from which the satellite signals are received at the respective locations;
storing corrections for at least respective portions of the predetermined spatial region around the predetermined object positions based on differences between the satellite distance measures and the calculated distance measures;
determining current satellite distance measures from the satellite signals of available satellites by a satellite-based receiving device at a current location of the object;
correcting the current satellite distance measures based on the corrections stored in the reference map to obtain corrected distance measures; and
determining a current object position based on the corrected distance measures.

32. The method as claimed in claim 31, wherein the reference map is represented by correction factors for a plurality of nodal points in the predetermined spatial region, and
wherein said correcting of the current satellite distance measures is based on the correction factors for a nearby nodal point closest to an estimated object position.

33. The method as claimed in claim 32,
wherein the current object position is used in back-calculating at least one of the calculated distance measures, and
wherein said storing of the corrections for the current object position is performed concurrently with said determining of the current object position.

34. The method as claimed claim 33, wherein the reference map is stored on a central computing unit,
wherein said method further comprises transferring at least one portion of the reference map to the object, and
wherein said correcting of the current satellite distance measures is performed at the object based on the corrections stored in the at least one portion of the reference map.

35. The method as claimed claim 33,
wherein said storing, said correcting and said determining of the current object position are performed by a central computing unit, and
wherein said method further comprises
transferring the current satellite distance measures determined at the current location of the object to the central computing unit; and
transferring the current object position from the central computing unit to the object.

36. A device for computer-aided generation and/or updating of a reference map for satellite-based positioning of an object, the reference map storing a correction for a predetermined spatial region to correct, as a position of the object in the predetermined spatial region is determined, distance measures from the object to a satellite based on a satellite signal received by at least one satellite-based receiving device at the object, comprising:
determining means for determining satellite distance measures at a plurality of locations of the object in the predetermined spatial region from satellite signals received by the at least one satellite-based receiving device;
obtaining means for obtaining a predetermined object position for a selected location in the plurality of locations;
calculating means for obtaining calculated distance measures corresponding to the predetermined object position by back-calculating from the predetermined object position and satellite positions of satellites from which the satellite signals are received at the selected location; and
storing means for storing corrections for at least a portion of the predetermined spatial region around the predetermined object position based on a difference between the satellite distance measures and the calculated distance measures.

37. The device as claimed in claim 36, wherein the reference map is represented by correction factors at a plurality of nodal points in the predetermined spatial region, and
wherein said storing means stores the correction factors for at least one nodal point in spatial proximity to the predetermined object position.

38. A device for satellite-based position detecting of an object based on a reference map generated and/or updated by storing a correction for a predetermined spatial region to correct distance measures from the object to a satellite, comprising:
first determining means for determining satellite distance measures at a plurality of locations of the object in the predetermined spatial region from satellite signals received by at least one satellite-based receiving device;
obtaining means for obtaining predetermined object positions for respective locations;
calculating means for obtaining calculated distance measures corresponding to the predetermined object positions by back-calculating from the predetermined object positions and satellite positions of satellites from which the satellite signals are received at the respective locations;
storing means for storing corrections for at least respective portions of the predetermined spatial region around the predetermined object positions based on differences between the satellite distance measures and the calculated distance measures;
second determining means for determining current satellite distance measures from the satellite signals of available satellites by a satellite-based receiving device at a current location of the object;
correcting means for correcting the current satellite distance measures based on the corrections stored in the reference map to obtain corrected distance measures; and
third determining means for determining a current object position based on the corrected distance measures.

39. The device as claimed in claim 38,
wherein the current object position is used in back-calculating at least one of the calculated distance measures, and
wherein said storing means stores the corrections for the current object position concurrently with determination of the current object position.
